(19) United States
(12) Patent Application Publication
(10) Pub. No.: US 2023/0340257 A1
(43) Pub. Date: Oct. 26, 2023

(54) POLYMER COMPOSITE COMPRISING FLOUR OF PULSE

(71) Applicant: CODA Intellectual Property B.V., s'Gravenhage (NL)

(72) Inventor: Daniel Eric Lynch, Rotterdam (NL)

(73) Assignee: CODA Intellectual Property B.V., s'Gravenhage (NL)

(21) Appl. No.: 18/193,105

(22) Filed: Mar. 30, 2023

Related U.S. Application Data
(63) Continuation of application No. PCT/NL2021/050590, filed on Sep. 29, 2021.

(30) Foreign Application Priority Data
Sep. 30, 2020 (NL) 2026591

(51) Int. Cl. C08L 67/04; C08L 99/00; C08K 5/00; C08J 5/18

(52) U.S. Cl. CPC C08L 67/04; C08L 99/00; C08K 5/0016; C08J 5/18; C08L 2205/06; C08L 2201/06; C08L 2203/12; C08J 2367/04; C08J 2467/04; C08J 2399/00; C08J 2499/00

(57) ABSTRACT

The invention concerns a polymer composite comprising:

a. biodegradable polymer in an amount of 5-94.5% by weight of the overall weight;

b. flour of pulse in an amount of at least 5% by weight of the overall weight;

c. plasticizer in an amount from 5-50% w/w of component b);

d. optional filler, and

e. optional additive,

wherein

c) is a solid plasticizer with a melting temperature in the range of 70 to 210°. The invention also concerns a process for its preparation, an intermediate, and a solid article comprising the polymer composite.

### CROSS REFERENCE TO RELATED APPLICATIONS

This application is a continuation of International Application No. PCT/NL2021/050590, filed on 29 Sep. 2021, which claims priority to Netherlands Application No. 2026591 NL, filed 30 Sep. 2020, the contents of each of which are hereby incorporated by reference in their entirety herein.

### TECHNICAL FIELD

This invention concerns a polymer composite comprising flour of pulse. More in particular, this invention concerns a polymer composite comprising an increased amount of flour of pulse.

### BACKGROUND

Pulses are annual leguminous crops yielding from one to twelve grains or seeds of variable size, shape and colour within a pod. They are used for both food and feed. They are harvested solely for dry seed. Dried beans, lentils and peas are the most commonly known and consumed types of pulses. Pulses do not include crops which are harvested green (e.g. green peas, green beans)—these are classified as vegetable crops. Also excluded are those crops used mainly for oil extraction (e.g. soybean and groundnuts) and leguminous crops that are used exclusively for sowing purposes (e.g. seeds of clover and alfalfa). Pulses contain carbohydrates, mainly starches (55-65 percent of the total weight); proteins, including essential amino acids (18-25 percent, and much higher than cereals); and fat (1-4 percent). The remainder consists of water and inedible substances. Examples of pulses according to the FAO (http://www.fao.org/es/faodef/fdef04e.htm, © 1994) include the following:

| FAO- | |
|---|---|
| STAT | |
| CODE | COMMODITY |
| 0176 | BEANS, DRY Phaseolus spp.: kidney, haricot bean (Ph. |
| | vulgaris); lima, butter bean (Ph. lunatus); adzuki bean (Ph. |
| | angularis); mungo bean, golden, green gram (Ph. aureus); black |
| | gram, urd (Ph. mungo); scarlet runner bean (Ph. coccineus); rice |
| | bean (Ph. calcaratus); moth bean (Ph. aconitifolius); tepary bean |
| | (Ph. acutifolius) |
| 0181 | BROAD BEANS, DRY Vicia faba: horse-bean (var. equina); |
| | broad bean (var. major); field bean (var. minor) |
| 0187 | PEAS, DRY garden pea (Pisum sativum); field pea (P. arvense) |
| 0191 | CHICK-PEAS chickpea, Bengal gram, garbanzos (Cicer |
| | arietinum) |
| 0195 | COW PEAS, DRY cowpea, blackeye pea/bean (Vigna sinensis; |
| | Dolichos sinensis) |
| 0197 | PIGEON PEAS pigeon pea, cajan pea, Congo bean (Cajanus |
| | cajan) |
| 0201 | LENTILS (Lens esculenta; Ervum lens) |
| 0203 | BAMBARA BEANS bambara groundnut, earth pea (Voandzeia |
| | subterranea) |
| 0205 | VETCHES spring/common vetch (Vicia sativa) |
| 0210 | LUPINS (Lupinus spp.) |
| 0211 | PULSES NES Including inter alia: lablab or hyacinth bean |
| | (Dolichos spp.); jack or sword bean (Canavalia spp.); winged |
| | bean (Psophocarpus tetragonolobus); guar bean (Cyamopsis |
| | tetragonoloba); velvet bean (Stizolobium spp.); yam bean |
| | (Pachyrrhizus erosus); |
| 0212 | FLOUR OF PULSES, Produced through milling or grinding of |
| | pulses. This heading also includes meal. |

This current invention relates to pulses in general according to the above definition, but specifically focusses on field peas, faba beans and lupin beans.

Field peas (Pisum sativum arvense) are a type of common pea. In the UK it is grown in three varieties: Marrowfat, Blue, and White. Field peas are high in protein (22-24%), starch, fibre, and micronutrients. Pea starch (12.0% moisture) is composed of 35% amylose and 65% amylopectin.

Faba beans (Vicia faba), also known as the broad bean or fava bean, is a species of flowering plant in the pea and bean family Fabaceae. In the UK beans are classified as winter and spring beans and are further classified by pale or black hilum colour or tic. Winter beans are generally large seeded whereas spring beans are smaller seeded. Winter bean varieties contain between 26-29% protein content.

Lupin beans are a non-starch leguminous seed with a high protein content ranging from 30-45%. They are grown globally in three main varieties; blue (Lupinus angustifolius L.), yellow (Lupinus luteus L.) and white (Lupinus albus L.) lupins. Blue and yellow lupin seeds are mostly used for feed, while the white lupins are primarily grown for food uses and are the main variety grown in the UK.

With the addition of an appropriate plasticiser, a chemical that is mixed with e.g. milled field peas, with the purpose of preventing their inherent starch/protein chains from agglomerating, the plasticized powder can form a plastic composite with an appropriate polymer with high percentages of inclusion. The purpose of such is to either reduce fossil fuel based plastic content and/or create biodegradable/compostable composites with similar polymers.

That starch may be plasticized is known. For instance, from ACS Appl. Polym. Mater, 2020, 2, 2016-2026 it is known that glycerol outperforms sorbitol when plasticizing amylopectin starch. Polymer composites comprising pea starch are known, but this requires the additional step of isolating the starch. For instance, from J. Appl. Polym Sci 2011, 119, 24-39-2448, a comparison is known of sorbitol and glycerol as plasticizers for thermoplastic starch (TPS) in blends of TPS and polylactic acid (PLA). This study revealed that sorbitol as plasticizer for starch unfortunately has limited use because of its tendency to migrate to the surface and by its recrystallization over time. The materials thus eventually lose their homogeneity and become brittle. Of greater commercial interest are polymer composites using flour of pulses, e.g., the milled whole field peas. Such polymer composites are also known. Cf., Venkateswaran, D. & Dhawan, S. & Sablani, Shyam & Zhang, J. & Jiang, L. (2012). Field peas and poly (lactic acid) biocomposites: Preparation and physical properties. 18th IAPRI World Packaging Conference. 465-472. The authors of this article studied the preparation of biocomposites using poly(lactic acid) (PLA) and field peas and investigated the influence of glycerol on the physical properties of the PLA/pea composites. The tests revealed that the biocomposites had lower strength compared to neat PLA. Within the formulation range, samples with 0% glycerol had the highest tensile strength but the lowest flexibility, at lower than 10%. Addition of up to 10% glycerol for both formulations increased flexibility to ˜20% without significant loss in strength or modulus. 20% glycerol samples for both formulations showed flexibility increased by 3× times with a significant reduction in strength. The article ends with a discussion inviting further studies on exact levels of glycerol to obtain an ideal biocomposite utilizing 50:50 Peas:PLA to be conducted for industrial applications in the food service items.

The purpose of the present invention is to find a solution that allows inclusion of greater amounts of flour of pulse, e.g. milled whole field peas, without loss of strength or flexibility. Moreover, the purpose of the present invention is to find polymer composites that can be moulded, e.g., into disposable articles such as coffee capsules, cutlery, straws, drink stirrers, food trays, single-serve packaging, such as a cup, cap, container and/or lid, or any other single-use item, etc., with sufficient strength to form a disposable article with a wall thickness larger than 250 micrometres, whereas the polymer composites are biodegradable.

### SUMMARY OF THE INVENTION

A polymer composite is provided as claimed in claim 1, comprising:
a. biodegradable polymer in an amount of 5-94.5% by weight of the overall weight;
b. flour of pulse in an amount of at least 5% by weight of the overall weight;
c. plasticizer in an amount from 5-50% w/w of component b);
d. optional filler, and
e. optional additive,
   wherein
   c) is a solid plasticizer with a melting temperature in the range of 70 to 210° C.

Also provided is a process for preparing the polymer composite, an intermediate for preparing the polymer composite and articles comprising the polymer composite.

### DETAILED DESCRIPTION OF THE INVENTION

It has been found that with the addition of at least 5%, preferably at least 15% by weight of a solid plasticizer based on the flour of pulse, optionally together with an appropriate filler, the flour of pulse can form a plastic composite material with a thermoplastic polymer even at high loading levels, e.g., higher than 20% w/w or even higher than 40% w/w based on the flour of pulse and polymer, with sufficient strength to form a disposable article with a wall thickness larger than 250 micrometres (10 mils), and sufficient biodegradability.

For use in the present invention, any type of pulse as defined above can be used as component b). This current invention specifically focusses on flour of pulse based on any one or more of field peas, faba beans and lupins. Prior to compounding, the pulse may be milled to a fine powder, having a particle size smaller than 1 mm, preferably smaller than 500 micrometres. This is preferably done in multiple stages to obtain a uniform small particle size. For instance, milled blue field pea powder may be used. Similar considerations apply with respect to faba beans, e.g., using milled winter faba bean powder, lupin beans, e.g., milled white lupin powder, or combinations thereof.

Milling is preferably carried out on dry material e.g. in order to more easily obtain a uniform small particle size and/or to reduce the amount of introduced liquid such as water. In an embodiment, materials may thus be dried prior to milling. Hence, although in this specification, materials may only be referred to as being milled, the present invention alternatively or additionally refers to embodiments in which the materials are dried milled and thus, if necessary, the wording “milled” may be replaced throughout the specification by the wording “dried milled” where appropriate. In other words, “milled” has to be interpreted as meaning “milled and/or dried milled” unless specifically stated otherwise.

The flour of pulse may be used at low loading levels, starting at 5% by weight of the overall weight, but preferably is used at loading levels in excess of 20%, e.g., at loading levels of 20-90%, more preferably at loading levels of 20-80%, still more preferably at loading levels of 20-70% by weight of the overall weight, or at loading levels in excess of 40%, e.g., at loading levels of 40-90%, more preferably at loading levels of 40-80%, still more preferably at loading levels of 40-70% by weight of the overall weight. The flour of pulse may be mixed, e.g. up to 100%, preferably up to 50% by weight of component b), with milled expeller/meal/cake, milled pomace, milled distillers' grain, milled brewer's grain (or brewer's spent grain/draff), milled biscuit meal (or biscuit cereal meal), coffee grounds, milled whole seeds, milled whole roots, milled whole beans, milled stems and/or leaves, and whole grain flour of cereal grass, or combinations thereof. For instance, a mixture of two materials such as milled whole field peas and either rosehip meal, or areca catechu leaf sheath powder may be used. When mixing the flour of pulse with expellers, meals, and the like, the amount of solid plasticizer is still calculated on amount of the flour of pulse.

Suitable expellers may include but are not limited to the expeller of sunflower seeds, rapeseed, linseed, peanut, palm fruit, sesame seed, castor seed, and sugar beet pulp. Suitable meals may include but are not limited to the meal of sunflower, borage, cottonseed, Buglossoides arvensis (Ahiflower), safflower, rosehip, canola, blackcurrant, palm kernel, rapemeal, and evening primrose. Biscuit meal, or biscuit cereal meal, may include either a mixture of or the individual components of the crumbed waste of cooked and processed biscuit, cake and cereal food products. Cereal grasses include staple crops such as maize, wheat, rice, barley, oat and millet and hybrids such as triticale, as well as feed for animals, such as canary seeds. Suitable examples of pomace may include grape pomace, olive pomace, apple pomace, or the solid remains of other fruits or vegetables after pressing for juice or oil.

The biodegradable polymer may be mixed, e.g. up to 100%, preferably up to 50% by weight of component a), with any polymer. Suitable polymers to mix with the biodegradable polymer include synthetic and natural polymer, e.g., biobased and biodegradable polymers, but preferably a thermoplastic polymer is used.

The polymer composite may be made from any biodegradable polymer as component a), but preferably a thermoplastic polymer is used.

Suitable thermoplastic materials, either as biodegradable polymer or as polymer for mixing with the biodegradable polymer, include polyamides (such as nylon), acrylic polymers, polystyrenes, polypropylene (PP), polyethylene (including low-density polyethylene (LDPE) and high density polyethylene (HDPE), acrylonitrile butadiene styrene (ABS), polyglycolic acid, polycarbonates, polybenzimidazole, poly ether sulphone, polyether ether ketones (PEEK), polyetherimide, polyphenylene oxide, polyphenylene sulphide, polyvinyl chloride, and polytetrafluoroethylene, or any suitable mixture thereof.

Elastomers, or combinations of thermoplastic polymers with elastomers may also be used. Suitable elastomers, either as biodegradable polymer or as polymer for mixing with the biodegradable polymer, include natural and synthetic rubbers, chloroprene, neoprene, isoprene, polybutadiene, butyl rubber, halogenated butyl rubber, styrene-butadiene, nitrile rubber, latex, fluoroelastomers, silicone rubbers, epichlorhydrin, poly ether block amides, ethylene vinyl acetate (EVA) and ethylene vinyl alcohol (EVOH) for example. The elastomer may comprise a thermoplastic elastomer, which may be selected from styrenic block copolymers (TPE-s), thermoplastic olefins (TPE-o), elastomeric alloys (TPE-v or TPV), thermoplastic polyurethanes (TPU), thermoplastic copolyester (TPE-E) and thermoplastic polyamides, for example.

Thermoset polymers, or combinations of thermoplastic polymers with thermoset polymers may also be used. Suitable thermoset polymers, either as biodegradable polymer or as polymer for mixing with the biodegradable polymer, include epoxy resins, melamine formaldehyde, polyester resins and urea formaldehyde, for example.

Suitable acrylic polymers (which may be thermoplastics, thermosets or thermoplastic elastomers), either as biodegradable polymer or as polymer for mixing with the biodegradable polymer, include polyacrylic acid resins, polymethyl methacrylates, polymethyl acrylates, polyethyl acrylates, polyethyl ethacrylates, and polybutyl methacrylates, for example.

Suitable polyesters, either as biodegradable polymer or as polymer for mixing with the biodegradable polymer, include polyglycolide (PGA), polylactide or poly(lactic acid) (PLA), poly(lactide-co-glycolide) (PLGA), polycaprolactone (PCL), poly(butylene succinate) (PBS) and its copolymers, e.g. poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB) or other polyhydroxyalkanoates (PHA), poly(hydroxybutyrate-co-hydroxyvalerate) (PHBV), or any suitable mixture thereof. Most preferably either PLA or PBS is used as component a). Most preferably, for improved biodegradability, the polymer composite comprises either PLA or PBS in an amount between 30-50% w/w of the overall mixture.

Plasticizers are an important class of low molecular weight non-volatile compounds that are widely used in polymer industries as additives. Plasticizers for thermoplastics are, in general, high boiling point liquids, with average molecular weights of between 300 and 600, and linear or cyclic carbon chains (14-40 carbons). However, the purpose of the plasticizer for a biomaterial is to prevent agglomeration of the carbohydrate/protein chains so that the biomaterial mixes with the polymer and the two become a single plastic mass. For the purpose of the present invention, the plasticizer must be compatible with component b), and be different from component b).

Whereas in the prior art glycerol is used, the present invention requires the use of a solid plasticizer with a melting temperature in the range of 55 to 210° C., preferably in the range of 70 to 210° C., more preferably in the range of 80 to 210° C., and most preferably in the range of 90 to 210° C. The plasticizer may be selected from polyols, polyfunctional alcohols, amphipolar plasticizers such as carboxylic acids and esters, for instance mono, di-, and tri-glyceride esters; mono-, di- and oligosaccharides and combinations thereof. Polyols have been found to be particularly effective. Suitable plasticizers include sorbitol, maltitol, sucralose, threitol, erythritol, psicose, allose, talose, ribitol, tagatose, arabinose, galactitol, lactitol, arabitol, glyceraldehyde, iditol, sorbose, ribose, galactose, volemitol, mannitol, fucitol, xylose, xylitol, trehalose, cellobiose, raffinose, glucose, mannose, fructose, isomalt, polydextrose and sucrose; and/or combinations thereof. For instance, xylose, with a melting point of 144-145° C. and/or sorbitol, with a melting point of 94-96° C., and/or xylitol, with a melting point of 92-96° C. may be used. An advantage of using sorbitol over xylose is the higher tensile strength of the resulting polymer composite. An advantage of using xylitol over sorbitol and xylose is the higher tensile strength of the resulting polymer composite. Further, xylitol has a lower solubility in water then sorbitol meaning that when the polymer composite is used in solid articles that during use are subjected to water, e.g., hot water, as in a coffee machine, the chance of xylitol being dissolved into the water is lower.

Also a mixture of a solid plasticizer and a liquid plasticizer may be used, provided the mixture has a melting temperature in the range of 55 to 210° C., preferably in the range of 70 to 210° C., more preferably in the range of 80 to 210° C., and most preferably in the range of 90 to 210° C. The amount of liquid plasticizer is preferably small, e.g., up to 10% by weight of component c).

The plasticizer may be used in an amount from 15-50% w/w of component b), preferably between 22-40% w/w of component b).

Additional, optional components of the polymer composite include fillers, such as mineral fillers and/or natural fibres and/or carbon-based fillers.

Suitable mineral fillers include carbonates (including bicarbonates), phosphates, ferrocyanides, silica, silicates, aluminosilicates (including all forms of clay minerals, mica and talc), titanium dioxide, or combinations thereof. For instance, a nepheline syenite may be used or any similar filler derived from silica-undersaturated and peralkaline igneous rocks, as well as any type of bentonite.

Natural fibres include cellulose or lignocellulosic fibres such as plant or vegetable fibres from the blast, leaf, seed, wood, or stem. For instance, wood cellulose fibre may be used. Carbon based fillers include carbon nanotubes (CNT), graphene, fullerene, graphite, and amorphous carbon.

The filler may be used in an amount from 0-96% w/w of the overall mixture, preferably between 1-40% w/w of the overall mixture.

Optional additional components include compatibilizers, fragrances, heat and UV stabilizers, colouring agents and the like. Suitable compatibilizers include any acrylic grafted thermoplastics (for example: maleic anhydride grafted polyethylene, polypropylene, or polylactic acid), interface-active high-molecular-weight peroxides, poly(2-ethyl-2-oxazoline), any esters of citric add, aromatic carbodiimides (for example: BioAdimide from Lanxess), wax-based emulsion additives (for example: Aquacer from BYK Additives), organo-silane coupling agents, and isocyanate (or diisocyanate) coupling agents (for example: methylenediisocyanate).

The additional components may be used in an amount from 0-30% by weight of the overall mixture, preferably between 0-15% by weight of the overall mixture.

The polymer composite is made by so-called “hot compounding” techniques, where the components are combined under heat and shearing forces that bring about a state of molten plastic (fluxing) which is shaped into the desired product, cooled and allowed to develop ultimate properties of strength and integrity. Hot compounding includes calendering, extrusion, injection and compression moulding. This is carried out at temperatures, pressures and processing conditions specific to the selected polymer. For instance, when using PLA the temperature is preferably in the range of 130 to 215° C., more preferably in the range of 130 to 210° C., even more preferably in the range of 130 to 185° C., and most preferably between 130 to 165° C.

The polymer composite may also be made by a multistep process, wherein the flour of pulse is first compounded with the solid plasticizer and pelletized and the pellets or grinded pellets are then combined with the polymer. Additional components may be added in any of the steps of the multistep process. The present invention therefore also provides pellets or grinded pellets of flour of pulse compounded and pelletized with plasticizer and other components if any, as intermediate product for combination with the polymer to produce the polymer composite.

The result of the process can be in the form of a solid article (or layer or portion thereof) and may comprise a compounded pellet, extruded work-piece, injection-moulded article, blow moulded article, rota-moulded plastics article, two-part liquid moulded article, laminate, 3D printer filament, felt, woven fabric, knitted fabric, embroidered fabric, nonwoven fabric, geotextiles, fibres or a solid sheet, for example.

The solid article may be in the form of a coffee capsule, cutlery, straw, drink stirrer, food tray, or single-serve packaging, such as a cup, cap, container and/or lid, or any other single-use item.

The solid article is preferably suited to be used and/or cleaned in water environments with a temperature above room temperature, preferably a temperature above 30° C., more preferably a temperature above 50° C., even more preferably a temperature above 60° C., and most preferably a temperature above 80° C. The solid article may for instance be used in a coffee machine using water at a temperature between 80 to 100° C., e.g., between 87 and 92° C.

The solid article is preferably suited to be used under pressure, e.g., a pressure above 2 bar, preferably a pressure above 4 bar, more preferably a pressure above 6 bar, and most preferably a pressure above 8 bar, e.g. as used in a coffee machine.

The solid article preferably has a minimum thickness above 250 micrometres, preferably above 350 micrometres, more preferably above 500 micrometres, and most preferably above 600 micrometres.

The invention is illustrated by the below examples.

### Example 1

275 grams of PLA (Ingeo® 3251 D from Natureworks LLC), 225 grams of blue field pea powder milled in a laboratory grain mill grinder and 67.5 grams of xylose (sieved through a 1 mm sieve) was mixed in a sealed plastic bag into a homogenous mixture (Mixture 1).

### Example 2

275 grams of Ingeo 3251 D PLA, 225 grams of winter faba bean powder milled in a laboratory grain mill grinder and 67.5 grams of xylose (sieved through a 1 mm sieve) was mixed in a sealed plastic bag into a homogenous mixture (Mixture 2).

### Example 3

275 grams of Ingeo 3251 D PLA, 225 grams of white lupin powder milled in a laboratory grain mill grinder and 67.5 grams of xylose (sieved through a 1 mm sieve) was mixed in a sealed plastic bag into a homogenous mixture (Mixture 3).

### Example 4

275 grams of Ingeo 3251 D PLA, 225 grams of blue field pea powder milled in a laboratory grain mill grinder and 67.5 grams of sorbitol (sieved through a 1 mm sieve) was mixed in a sealed plastic bag into a homogenous mixture (Mixture 4).

### Example 5

275 grams of Ingeo 3251 D PLA, 225 grams of winter faba bean powder milled in a laboratory grain mill grinder and 67.5 grams of sorbitol (sieved through a 1 mm sieve) was mixed in a sealed plastic bag into a homogenous mixture (Mixture 5).

### Example 6

275 grams of Ingeo 3251 D PLA, 225 grams of white lupin powder milled in a laboratory grain mill grinder and 67.5 grams of sorbitol (sieved through a 1 mm sieve) was mixed in a sealed plastic bag into a homogenous mixture (Mixture 6).

### Example 7

275 grams of Ingeo 3251 D PLA, 225 grams of blue field pea powder milled in a laboratory grain mill grinder and 67.5 grams of xylitol (sieved through a 1 mm sieve) was mixed in a sealed plastic bag into a homogenous mixture (Mixture 7).

### Example 8

275 grams of Ingeo 3251 D PLA, 225 grams of winter faba bean powder milled in a laboratory grain mill grinder and 67.5 grams of xylitol (sieved through a 1 mm sieve) was mixed in a sealed plastic bag into a homogenous mixture (Mixture 8).

### Example 9

275 grams of Ingeo 3251 D PLA, 225 grams of white lupin powder milled in a laboratory grain mill grinder and 67.5 grams of xylitol (sieved through a 1 mm sieve) was mixed in a sealed plastic bag into a homogenous mixture (Mixture 9).

### Example 10

275 grams of Ingeo 3251 D PLA, 150 grams of blue field pea powder milled in a laboratory grain mill grinder, 75 grams of evening primrose meal milled in a laboratory grain mill grinder and 67.5 grams of xylitol (sieved through a 1 mm sieve) was mixed in a sealed plastic bag into a homogenous mixture (Mixture 10).

### Example 11

275 grams of Ingeo 3251 D PLA, 150 grams of blue field pea powder milled in a laboratory grain mill grinder, 75 grams of Ahiflower meal milled in a laboratory grain mill grinder and 67.5 grams of xylitol (sieved through a 1 mm sieve) was mixed in a sealed plastic bag into a homogenous mixture (Mixture 11).

### Example 12

115.4 grams of blue field pea powder milled in a laboratory grain mill grinder, 34.6 grams of xylitol (sieved through a 1 mm sieve) and 350 grams of compounded pellets containing 60% Ingeo 3251 D PLA and 40% wood cellulose fibre (supplied by Sappi Maastricht BV) was mixed in a sealed plastic bag into a homogenous mixture (Mixture 12).

### Example 13

115.4 grams of winter faba bean powder milled in a laboratory grain mill grinder, 34.6 grams of xylitol (sieved through a 1 mm sieve) and 350 grams of compounded pellets containing 60% Ingeo 3251 D PLA and 40% wood cellulose fibre (supplied by Sappi Maastricht BV) was mixed in a sealed plastic bag into a homogenous mixture (Mixture 13).

### Example 14

84 grams of blue field pea powder milled in a laboratory grain mill grinder, 42 grams of Ahiflower meal milled in a laboratory grain mill grinder and 25.2 grams of xylitol (sieved through a 1 mm sieve) and 350 grams of compounded pellets containing 60% Ingeo 3251 D PLA and 40% wood cellulose fibre (supplied by Sappi Maastricht BV) was mixed in a sealed plastic bag into a homogenous mixture (Mixture 14).

### Example 15

150 grams of Ingeo 3251 D PLA, 192 grams of blue field pea powder milled in a laboratory grain mill grinder, 58 grams of xylitol (sieved through a 1 mm sieve) and 100 grams of HiFill™ N800 (nepheline syenite powder as inorganic filler from Sibelco UK Ltd) was mixed in a sealed plastic bag into a homogenous mixture (Mixture 15).

### Example 16

150 grams of Ingeo 3251 D PLA, 192 grams of winter faba bean powder milled in a laboratory grain mill grinder, 58 grams of xylitol (sieved through a 1 mm sieve) and 100 grams of HiFill N800 was mixed in a sealed plastic bag into a homogenous mixture (Mixture 16).

### Example 17

150 grams of Ingeo 3251 D PLA, 192 grams of blue field pea powder milled in a laboratory grain mill grinder, 58 grams of xylitol (sieved through a 1 mm sieve) and 100 grams of Premium Quest™ Bentonite (calcium bentonite powder as inorganic filler from Amcol Minerals Europe Ltd) was mixed in a sealed plastic bag into a homogenous mixture (Mixture 17).

### Example 18

150 grams of Ingeo 3251 D PLA, 192 grams of winter faba bean powder milled in a laboratory grain mill grinder, 58 grams of xylitol (sieved through a 1 mm sieve) and 100 grams of Premium Quest Bentonite was mixed in a sealed plastic bag into a homogenous mixture (Mixture 18).

### Examples 19-32

Mixtures 1-14 (from Examples 1-14) were individually poured into the hopper of a Negri Bossi v55 injection moulding machine with a 32 mm diameter screw and a L/D ratio of 20:1 operating at temperatures ranging from 130 to 165° C. Each molten plasticized mixture was injection moulded in a single-cavity tool fitted with a single-drop hotrunner system into capsules suitable for use in a Nespresso®-style coffee machine.

### Examples 33-36

Mixtures 15-18 (from Examples 15-18) were individually poured into the hopper of a Negri Bossi v55 injection moulding machine with a 32 mm diameter screw and a L/D ratio of 20:1 operating at temperatures ranging from 130 to 165° C. Each molten plasticized mixture was injection moulded in a twin-cavity tool fitted with a single-drop hotrunner system into drink stirrer sticks suitable for stirring beverages.

### Example 37

6 kgs of blue field peas were milled in a Magico EMC70 electric mill from AMA S.p.A. fitted with a 1 mm sieve. The resultant flour was then mixed with a combination of 3 kgs of Ahiflower meal that had been run through the same electric mill to break up any agglomerated clumps plus 30% by weight of the two powders of xylitol (sieved through a 2 mm sieve) in a tumble mixer to create a mixed powder of about 11.7 kgs weight. This mixture was then compounded with Ingeo 3251 D PLA in a ratio of 64:36 peas/Ahiflower/xylitol:PLA on a Werner and Pfleiderer ZSK 25 twin-screw compounder fitted with a ZS-B 25 twin-screw side feeder. The screw profile used is given in Table 1 along with the respective injection points for the component materials. The temperature settings along the barrel were 170, 190, 170, 170, 170, 170, 170, 170° C. The compounded filament was cooled in a water bath, dried under an air knife and pelletized using a SG-E 60 from Intelligent Pelletizing Solutions GmbH & Co KG. Pellets were dried overnight in a Dryplus 250 from Vismec s.r.l at 80° C.

TABLE 1
Screw profile with material inclusion points

| | | |
|---|---|---|
| Conveying | 16/16 | (PLA) |
| | 36/36 (×2) | |
| | 36/18 | |
| | 36/36 | |
| | 36/18 | |
| Kneading | 45/5/36 | |
| | 45/5/18 | |
| | 45/5/18 (×2) | |
| Conveying | 36/36 (×5) | (peas/Ahiflower/xylitol) |
| Kneading | 45/5/36 (×3) | |
| Conveying | 36/36 | |
| Kneading | 45/5/24 (×3) | |
| Conveying | 16/16 | |
| | 36/36 (×2) | |
| Kneading | 45/5/12 (×2) | |
| | 90/5/24 | |
| Conveying | 36/36 | |
| Kneading | 45/5/12 (×2) | |
| | 45/5/12 | |
| Conveying | 36/36 (×5) | |
| | 24/24 (×4) | |

### Example 38

Compounded pellets from Example 37 were mixed in equal weight portions with compounded pellets containing 60% Ingeo 3251 D PLA and 40% wood cellulose fiber (supplied by Sappi Maastricht BV) and fed into the hopper of a Krauss Maffei 120-180 PX injection moulding machine with a 25 mm diameter screw operating at temperatures ranging from 200 to 215° C. The molten plasticized mixture was injection moulded in an eight-cavity tool fitted with a valve-gate hotrunner system into capsules suitable for use in a Nespresso-style coffee machine.

### Example 39

Representative coffee capsules from Examples 19-32 were filled to level capacity with ground coffee grains and sealed with self-sealing aluminium coffee capsule lids. Filled pods were then tested in a standard Nespresso coffee machine to produce a volume of filtered coffee. All capsules tested produced approximately the same volume of coffee as expelled from a commercial Nespresso capsule.

### Example 40

Representative coffee capsules from Example 38 were filled to level capacity with ground coffee grains and sealed using Green Capsule top lids (Ahlstrom-Munksjö Oyj) on a laboratory rig with a heated ring that could be lowered and raised in an appropriate position to bond the pre-cut circular lid film to the rim of the coffee capsule. Filled capsules were then tested in a standard Nespresso coffee machine to produce a volume of filtered coffee. All capsules tested produced approximately the same volume of coffee as expelled from a commercial Nespresso capsule.

### Examples 41-42

Fifteen representative coffee capsules from Examples 25 and 26 (weight: 2.54±0.01 g and 2.52±0.01 g respectively) were respectively mixed into 2 kgs of commercially purchased topsoil (passed through a 4 mm sieve) containing enough distilled water to saturate (defined by not leaving any standing water) the soil in a 5 L Pyrex glass beaker covered with 20 cm diameter watch glass. The beaker was placed inside a Unitemp temperature-controlled oven set at 58° C. (as per the thermophilic incubation period as detailed in IS020200-2015). The trial was left undisturbed for separate periods of 21 days up to a total of 90 days.

Upon extraction and cooling to room temperature of the glass beaker at the end of each 21 day trial period, the soil was carefully broken apart to extract any intact capsules. Following extraction of both capsules and the larger pieces of broken capsules the soil was again sifted through a 4 mm sieve to extract any remaining pieces. All pieces were dried and then carefully brushed with a toothbrush to remove any attached dirt before being photographed and returned to re-saturated soil for another 21 day trial period until the end of the 90 day trial period. At the end of the 90 day trial period all capsules had completely disintegrated with no discernable pieces remaining in the 4 mm sieve.

### SUMMARY

Examples 1-9 illustrate polymer composites with a high loading of flour of pulse. In Example 10 the combination of flour of pulse with evening primrose meal is illustrated, whereas in Examples 11 and 38 the combination with Ahiflower meal is illustrated. In Examples 12-14 plus 38, wood cellulose filler has been used, whereas in Examples 15-18, mineral fillers have been used.

All formulations allowed the preparation of a disposable article, in this case a coffee capsule (Examples 19-32) and a drinks stirrer (Examples 33-36). The coffee capsules were strong enough to be used in a Nespresso® coffee machine, as shown in Examples 39 and 40. Moreover, the coffee capsules made from either peas or faba beans proved to be highly biodegradable, as shown in Examples 41 and 42.

The invention can be summarized by the following clauses:
1. Polymer composite comprising:
   a. polymer in an amount of 5-94.5% by weight of the overall weight;
   b. flour of pulse, in an amount of at least 5% by weight of the overall weight;
   c. plasticizer in an amount from 5-50% w/w of component b);
   d. optional filler, and
   e. optional additive,
      wherein
      c) is a solid plasticizer with a melting temperature in the range of 55 to 210° C.
2. Polymer composite as claimed in clause 1, wherein component a) comprises a biodegradable polymer, preferably PLA, or derivatives or polymer blends thereof.
3. Polymer composite as claimed in clause 2, wherein component a) is present in an amount of 30-70% by weight of the overall weight, preferably in an amount of 30-50% by weight of the overall weight.
4. Polymer composite as claimed in any of the preceding clauses, wherein component b) comprises milled whole field peas, or milled whole faba beans, or milled whole lupin beans, or a mixture thereof.
5. Polymer composite as claimed in any of the preceding clauses, comprising a mixture of flour of pulse and up to 50% w/w of component b) of milled expeller/meal/cake, milled pomace, milled distillers' grain, milled brewer's grain (or brewer's spent grain/draff), milled biscuit meal or individual components thereof, milled whole seeds, milled whole roots, milled whole beans, milled stems and/or leaves, milled whole grain flour of cereal grass, or a mixture thereof.
6. Polymer composite as claimed in any of the preceding clauses, wherein component b) or the mixture of claim 5 is present in an amount of 30-70% by weight of the overall weight.
7. Polymer composite as claimed in any of the preceding clauses, comprising polyols, polyfunctional alcohols, amphipolar plasticizers such as carboxylic acids and esters, for instance mono, di-, and tri-glyceride esters; mono-, di- and oligosaccharides, or mixtures thereof, as component c).
8. Polymer composite as claimed in any of the preceding clauses, wherein component c) is present in an amount from 22 to 40% w/w of component b).
9. Polymer composite as claimed in any of the preceding clauses, comprising as component d) either a natural fibre, preferably cellulose or lignocellulose fibres, and/or a mineral filler preferably selected from carbonates (including bicarbonates), phosphates, ferrocyanides, silica, silicates, aluminosilicates (including all forms of clay minerals and talc), titanium dioxide, and/or a carbon-based filler, or combinations thereof.
10. Polymer composite as claimed in any of the preceding clauses, wherein component d) is present in an amount from 1-40% by weight of the overall weight.
11. Polymer composite as claimed in any of the preceding clauses, comprising compatibilizers, fragrances, heat and UV stabilizers, and/or colouring agents or a mixture thereof as additive.
12. A process for preparing the polymer composite as claimed in any of the preceding clauses, wherein the polymer composite is made by hot compounding techniques, where the components are combined under heat and shearing forces that bring about a state of molten plastic (fluxing) which is shaped into the desired product, cooled and allowed to develop ultimate properties of strength and integrity, preferably by calendering, extrusion, injection and compression moulding.
13. The process of the preceding clause, carried out at temperatures in the range of 130 to 210° C.
14. The process of clause 12 or 13, carried out in two steps, forming an intermediate first in a first step and combining the intermediate with the remainder of the components in a second step.
15. A solid article comprising the polymer composite as claimed in any of the preceding clauses 1-11.
16. The solid article of the preceding clause, in the form of a compounded pellet, extruded work-piece, injection-moulded article, blow moulded article, film or rota-moulded plastic article, two-part liquid moulded article, laminate, 3D printer filament, felt, woven fabric, knitted fabric, embroidered fabric, nonwoven fabric, geotextiles, fibre or a solid sheet.
17. The solid article of clause 15 or 16, in the form of a coffee pod, cutlery, food tray, or single-serve packaging.
18. An intermediate as prepared by the process of clause 14, for use in the preparation of a polymer composite as claimed in any of the preceding clauses 1-11.

What is claimed is:

1. A polymer composite having an overall weight, comprising:
(a) a biodegradable polymer in an amount of 5-94.5% by weight of the overall weight;
(b) flour of pulse, in an amount of at least 5% by weight of the overall weight; and
(c) a plasticizer in an amount from 5-50% w/w of component of the flour of pulse;
wherein the plasticizer is a solid plasticizer having a melting temperature in the range of 70 to 210° C.

2. The polymer composite of claim 1, wherein the biodegradable polymer is chosen from polyglycolide (PGA), polylactide or poly(lactic acid) (PLA), poly(lactide-co-glycolide) (PLGA), polycaprolactone (PCL), poly(butylene succinate) (PBS) and its copolymers, poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB), polyhydroxyalkanoates (PHA), poly(hydroxybutyrate-co-hydroxyvalerate) (PHBV), mixtures thereof, and derivatives and polymer blends thereof.

3. The polymer composite of claim 1, wherein the biodegradable polymer is present in an amount of 30-70% by weight of the overall weight.

4. The polymer composite of claim 1, wherein the flour of pulse is chosen from milled whole field peas, milled whole faba beans, and milled whole lupin beans, and mixtures thereof.

5. The polymer composite of claim 1, comprising a mixture of flour of pulse and up to 100% w/w of flour of pulse chosen from milled expeller/meal/cake, milled pomace, milled distillers' grain, milled brewer's grain (or brewer's spent grain/draff), milled biscuit meal, individual components of said mixture, coffee grounds, milled whole seeds, milled whole roots, milled whole beans, milled stems and leaves, milled whole grain flour of cereal grass, and mixtures thereof.

6. The polymer composite of claim 1, wherein the flour of pulse is present in an amount of 20-70% by weight of the overall weight.

7. The polymer composite of claim 1, wherein the plasticizer is chosen from polyols, polyfunctional alcohols, amphipolar plasticizers, carboxylic acids and esters, mono, di-, and tri-glyceride esters, mono-, and di-oligosaccharides, and mixtures thereof.

8. The polymer composite of claim 1, wherein the plasticizer is present in an amount from 22 to 40% w/w of the flour of pulse.

9. The polymer composite of claim 1, further comprising a filler, wherein the filler is chosen from natural fibre, cellulose, lignocellulose fibres, a mineral filler, carbonates, bicarbonates, phosphates, ferrocyanides, silica, silicates, aluminosilicates, comprising clay minerals, mica and talc, titanium dioxide, a carbon-based filler, and combinations thereof.

10. The polymer composite of claim 1, further comprising a filler, wherein the filler is present in an amount of 1-40% by weight of the overall weight.

11. The polymer composite of claim 1, further comprising an additive, wherein the additive is chosen from compatibilizers, fragrances, heat and UV stabilizers, colouring agents, and mixtures thereof.

12. A process for preparing a polymer composite, comprising a biodegradable polymer, flour of pulse, and a plasticizer, wherein the plasticizer is a solid plasticizer having a melting temperature in the range of 70 to 210° C., as components, comprising combining the components under heat and shearing forces forming a molten plastic; shaping the molten plastic into a formed molten plastic by a process chosen from calendering, extrusion, injection and compression moulding; and cooling the shaped molten plastic.

13. The process of claim 12, wherein said step of shaping the molten plastic is performed at temperatures in the range of 130 to 215° C.

14. The process of claim 12, further comprising the steps of forming an intermediate from at least one component, and combining the intermediate with the previously unused components.

15. A solid article comprising a biodegradable polymer, flour of pulse, and a plasticizer, wherein the plasticizer is a solid plasticizer having a melting temperature in the range of 70 to 210° C.

16. The solid article of claim 15, wherein the solid article has a form chosen from a compounded pellet, extruded work-piece, injection-moulded article, blow moulded article, rota-moulded plastic article, two-part liquid moulded article, laminate, 3D printer filament, felt, woven fabric, knitted fabric, embroidered fabric, nonwoven fabric, geotextiles, fibre and a solid sheet.

17. The solid article of claim 15, wherein the solid article has a form chosen from a coffee capsule, cutlery, straw, drink stirrer, food tray, or single-serve packaging, such as a cup, cap, container, lid, and other single-use items.

18. The polymer composite of claim 3, wherein the biodegradable polymer is present in an amount of 30-50% by weight of the overall weight.

19. The polymer composite of claim 5, wherein the mixture is present in an amount of 20-70% by weight of the overall weight.
